(19) United States
(12) Patent Application Publication
(10) Pub. No.: US 2025/0213894 A1
(43) Pub. Date: Jul. 3, 2025

(54) PERSONAL PROTECTIVE EQUIPMENT SYSTEM AND METHOD

(71) Applicant: 3M INNOVATIVE PROPERTIES COMPANY, St. Paul, MN (US)

(72) Inventors: James F. Poch, New Richmond, WI (US); Douglas D. Jensen, Woodbury, MN (US); Kevin W. Eberman, St. Paul, MN (US)

(21) Appl. No.: 18/850,833

(22) PCT Filed: Mar. 13, 2023
(86) PCT No.: PCT/IB2023/052398

§ 371 Date: Sep. 25, 2024

Related U.S. Application Data
(60) Provisional application No. 63/362,002, filed on Mar. 28, 2022.

(51) Int. Cl. A62B 18/00; H02J 7/00

(52) U.S. Cl. CPC A62B 18/00; H02J 7/0045

(57) ABSTRACT

A personal protective equipment (PPE) system is disclosed herein. The PPE system includes an article of PPE and a battery pack. The article includes a battery pack interface and one or more components. The battery pack includes a battery and electrical contacts configured to electrically connect the battery to the one or more components via the battery pack interface. The battery is configured to electrically power the components of the article via the electrical contacts. The battery pack further includes a switching arrangement electrically disposed between the electrical contacts and the battery. The battery pack further includes a battery controller configured to control the switching arrangement to electrically connect the electrical contact to the battery, and to electrically disconnect the electrical contact from the battery based on predefined conditions so as to prevent corrosion of the electrical contacts when a conductive liquid contacts the electrical contacts.

### TECHNICAL FIELD

The present disclosure relates generally to a personal protective equipment (PPE) system and a method of using a battery pack with an article of the PPE.

### BACKGROUND

Articles of personal protective equipment (PPE) are widely used for protection against exposure to hazards that can cause serious injuries and/or illnesses.

In some cases, an article of PPE may be a powered device (i.e., the article of PPE may include one or more components that require electrical power to operate). In such cases, a battery pack may be used to power the one or more components of the article of PPE.

The articles of PPE are often used in harsh, dirty, and/or unsanitary environments. As a result, the article of PPE and the battery pack may need to be frequently cleaned. However, during cleaning, electrical contacts of the battery pack may be exposed to an electrically conductive liquid (e.g., water). If current is allowed to flow from the electrical contacts, the exposed electrical contacts may corrode or tarnish. For example, the exposed electrical contacts that are energized may corrode or de-plate due to presence of electrical potential through the electrically conductive liquid causing metallic ion exchange between the energized exposed electrical contacts. This additionally may drain energy stored in the battery pack and may further damage the electrical contacts.

In some cases, a protective wash strap may be mounted on the electrical contacts of the battery pack before cleaning thereof. However, the protective wash strap may block a portion of the battery pack, thereby preventing the blocked portion from being properly cleaned. Thus, the portion of the battery pack blocked by the protective wash strap may require a secondary cleaning step. Furthermore, the protective wash strap may be improperly installed or may dislodge during the cleaning process. As a result, the electrical contacts may get exposed to the electrically conductive liquid and start de-plating due to presence of battery voltage across the electrical contacts.

The de-plating of the electrical contacts may impact charging of the battery pack and operation of the article of PPE, as resistance at the electrical contacts may increase due to the de-plating. In some cases, due to high resistances, the electrical contacts may cause surrounding elements/plastics of the battery pack to soften or melt due to excessive heat during use.

Therefore, there is a need to eliminate the presence of battery voltage across the electrical contacts during charging, cleaning, or when the battery pack is not attached to the article of PPE.

### SUMMARY

In a first aspect, the present disclosure provides a personal protective equipment (PPE) system. The PPE system includes an article of PPE including a battery pack interface. The article of PPE further includes one or more components that are electrically powered and configured to receive electrical power via the battery pack interface. The PPE system further includes a battery pack configured to physically and electrically connect to and disconnect from the battery pack interface of the article of PPE. The battery pack includes at least one battery. The battery pack further includes a plurality of electrical contacts configured to electrically connect the at least one battery to the one or more components of the article of PPE via the battery pack interface. The at least one battery is configured to electrically power the one or more components of the article of PPE via the plurality of electrical contacts. The battery pack further includes a switching arrangement electrically disposed between at least one electrical contact from the plurality of electrical contacts and the at least one battery. The switching arrangement is configured to selectively electrically connect the at least one electrical contact to the at least one battery and selectively electrically disconnect the at least one electrical contact from the at least one battery. The battery pack further includes a battery controller configured to control the switching arrangement to electrically connect the at least one electrical contact to the at least one battery. The battery controller controls the switching arrangement to electrically disconnect the at least one electrical contact from the at least one battery based on one or more predefined conditions so as to prevent corrosion of the plurality of electrical contacts when a conductive liquid contacts the plurality of electrical contacts.

In a second aspect, the present disclosure provides a method. The method includes providing an article of PPE. The article of PPE includes a battery pack interface and one or more components that are electrically powered and configured to receive electrical power via the battery pack interface. The method further includes providing a battery pack. The battery pack is configured to physically and electrically connect to and disconnect from the battery pack interface of the article of PPE. The battery pack includes at least one battery, a plurality of electrical contacts, and a switching arrangement. The plurality of electrical contacts is configured to electrically connect the at least one battery to the one or more components of the article of PPE via the battery pack interface. The at least one battery is configured to electrically power the one or more components of the article of PPE via the plurality of electrical contacts. The switching arrangement is electrically disposed between at least one electrical contact from the plurality of electrical contacts and the at least one battery. The switching arrangement is configured to selectively electrically connect the at least one electrical contact to the at least one battery and selectively electrically disconnect the at least one electrical contact from the at least one battery. The method further includes controlling the switching arrangement to electrically connect the at least one electrical contact to the at least one battery. The method further includes controlling the switching arrangement to electrically disconnect the at least one electrical contact from the at least one battery based on one or more predefined conditions so as to prevent corrosion of the plurality of electrical contacts when a conductive liquid contacts the plurality of electrical contacts.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic side perspective view of a personal protective equipment (PPE) system, according to an embodiment of the present disclosure, worn by a person;

FIG. 2 is a schematic block diagram of the PPE system of FIG. 1 according to an embodiment of the present disclosure;

FIG. 3 is a schematic block diagram of a PPE system according to another embodiment of the present disclosure;

FIG. 4 is a schematic block diagram of a PPE system according to another embodiment of the present disclosure;

FIG. 5 is a schematic circuit diagram of a battery pack of the PPE system of FIG. 4 according to an embodiment of the present disclosure;

FIG. 6 is a graph depicting exemplary electrical connection and electrical disconnection between a battery and electrical contacts of a battery pack of the PPE system of FIG. 4 with respect to time;

FIG. 7 is a schematic block diagram of a PPE system according to another embodiment of the present disclosure;

FIG. 8 is a schematic block diagram of a PPE system according to another embodiment of the present disclosure;

FIG. 9 is a schematic circuit diagram of a switching arrangement according to an embodiment of the present disclosure;

FIG. 10 is a schematic block diagram of a PPE system according to another embodiment of the present disclosure;

FIG. 11 is a block diagram of a PPE system according to another embodiment of the present disclosure; and

FIG. 12 is a flowchart depicting various steps of a method according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the following disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties).

The term “substantially”, unless otherwise specifically defined, means to a high degree of approximation (e.g., within +/−10% for quantifiable properties) but again without requiring absolute precision or a perfect match.

The term “about”, unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B”.

As used herein, the phrase “article of personal protective equipment” or “article of PPE” refers to any article that can be worn by an individual for the purpose of preventing or decreasing personal injury or health hazard to the individual. As it is to be worn by the individual, the article of PPE is portable. Examples of the article of PPE include safety glasses, safety goggles, face shields, face masks, respirators (such as a powered air purifying respirator), earplugs, earmuffs, gloves, suits, gowns, aprons, hard hats, etc.

As used herein, the term “battery” refers to an electrochemical storage device. A battery may include one or more electrochemical cells that convert stored chemical energy into electrical energy.

As used herein, the term “battery controller” refers to a computing device that couples to one or more other devices/circuits, e.g., battery circuits, switching circuits, etc., and which may be configured to communicate with, e.g., to control, such devices/circuits.

As used herein, the term “frequency” may refer to a resonant electrical frequency or an electro-magnetic frequency.

As used herein, the term “battery charger” refers to a device that provides electrical energy to a rechargeable battery, causing it to recharge.

The present disclosure provides a PPE system. The PPE system includes an article of PPE including a battery pack interface, and one or more components that are electrically powered and configured to receive electrical power via the battery pack interface. The PPE system includes a battery pack configured to physically and electrically connect to and disconnect from the battery pack interface of the article of PPE. The battery pack includes at least one battery. The battery pack further includes a plurality of electrical contacts configured to electrically connect the at least one battery to the one or more components of the article of PPE via the battery pack interface. The at least one battery is configured to electrically power the one or more components of the article of PPE via the plurality of electrical contacts. The battery pack further includes a switching arrangement electrically disposed between at least one electrical contact from the plurality of electrical contacts and the at least one battery. The switching arrangement is configured to selectively electrically connect the at least one electrical contact to the at least one battery and selectively electrically disconnect the at least one electrical contact from the at least one battery. The battery pack further includes a battery controller configured to control the switching arrangement to electrically connect the at least one electrical contact to the at least one battery. The battery controller controls the switching arrangement to electrically disconnect the at least one electrical contact from the at least one battery based on one or more predefined conditions so as to prevent corrosion of the plurality of electrical contacts when a conductive liquid contacts the plurality of electrical contacts.

The PPE system of the present disclosure may prevent corrosion of the plurality of electrical contacts of the battery pack, thereby allowing the battery pack of the PPE system to be immersed or submersed in the conductive liquid. Immersion of the article of PPE and the battery pack may be required in some market segments (e.g., pharmaceutical segments) in a liquid cleaning agent (which may be conductive) to minimize cross contamination. Thus, the article of PPE and the battery pack may be submersed in the conductive liquid while preventing corrosion of the plurality of electrical contacts. As a result, the article of PPE and the battery pack may be effectively cleaned.

The PPE system of the present disclosure may further improve electrical connectivity of the battery pack with the article of PPE. For example, the PPE system may eliminate or decrease undesired or inadvertent electrical disconnections of the battery pack from the article of PPE due to corrosion of the plurality of electrical contacts. Further, the PPE system may increase an operational life of the battery pack by preventing or reducing corrosion of the plurality of electrical contacts.

The PPE system and methods described herein may use minimal energy to avoid discharge of the at least one battery of the battery pack over a long period of time. For example, the PPE system may utilize a motion detector to minimize energy usage when the PPE system is not in use.

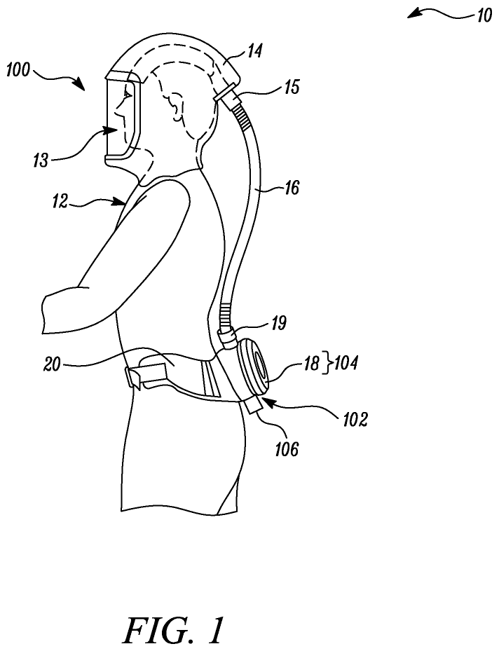

Referring now to figures, FIG. 1 illustrates a personal protective equipment (PPE) system 10 according to an embodiment of the present disclosure. Specifically, FIG. 1 illustrates a schematic perspective view of the PPE system 10 worn by a person 12. The person 12 may be an emergency personnel, such as a firefighter.

The PPE system 10 includes an article of PPE 100 (hereinafter, “the article 100”). In the illustrated embodiment of FIG. 1, the article 100 is a powered air purifying respirator (PAPR). Specifically, in the illustrated embodiment of FIG. 1, the article 100 includes a head or a face piece, such as a hood 14, a breathing tube 16, a turbo unit 18, and a turbo support, such as a belt 20.

The hood 14 may be worn on a head of the person 12 and may at least partially enclose the head of the person 12 to form a breathing zone 13, that is, an area around a nose and a mouth of the person 12, so that filtered air is directed to the breathing zone 13. The article 100 (PAPR in FIG. 1) may therefore provide respiratory protection to the person 12. Further, a turbo status indicator unit that houses turbo status indicators may be adapted to fit inside the hood 14 within a range of vision of the person 12 to indicate a current operating status of the turbo unit 18 (e.g., a speed of a fan of the turbo unit 18) to the person 12.

The turbo unit 18 may be attached to the belt 20 to secure the turbo unit 18 about a torso of the person 12. The turbo unit 18 may supply air to the hood 14 through the breathing tube 16, which is connected between an outlet 19 of the turbo unit 18 and an inlet 15 of the hood 14. Further, a turbo remote control unit (not shown), that houses turbo controls, may be adapted to be worn on a wrist of the person 12 to receive information or inputs from the person 12. Two or more of the turbo unit 18, the turbo status indicator unit, and the turbo remote control unit may be disposed in wireless communication with each other.

It may be noted that the article 100 may include any device or apparatus that is worn on a body of the person 12 and provides protection to the person 12 in a hazardous environment. In other words, the article 100 may be portable, such that the article 100 can be worn by the person 12 to provide protection to the person 12.

In some embodiments, the article 100 may include respiratory protection apparatuses/devices, such as a self-contained breathing apparatus (SCBA), a non-powered air purifying respirator (APR), a hose line, a half facemask, a full facemask, a half face respirator, a full face respirator, and the like, to provide respiratory protection to the person 12. That is, in some embodiments, the article 100 provides respiratory protection.

In some embodiments, the article 100 may include hearing protection devices, such as earmuffs and earplugs, to provide hearing protection to the person 12. That is, in some embodiments, the article 100 provides hearing protection. In some embodiments, the article 100 may include vision protection devices, such as an eyewear, to provide vision protection to the person 12. That is, in some embodiments, the article 100 provides vision protection.

In some embodiments, the article 100 may include fall protection devices/apparatuses, such as a harness, to provide fall protection to the person 12. That is, in some embodiments, the article 100 provides fall protection. Furthermore, in some embodiments, the article 100 may include head protection devices/apparatuses, such as a helmet, to provide head protection to the person 12. That is, in some embodiments, the article 100 provides head protection.

The article 100 includes a battery pack interface 102. The battery pack interface 102 may detachably receive a battery pack. The article 100 further includes one or more components 104 that are electrically powered and configured to receive electrical power via the battery pack interface 102. For example, the one or more components 104 may include the turbo unit 18 and any other component of the article 100 that requires electrical power to operate.

The PPE system 10 further includes a battery pack 106 configured to physically and electrically connect to and disconnect from the battery pack interface 102 of the article 100. The battery pack interface 102 may detachably receive the battery pack 106. The battery pack interface 102 may include at least one terminal and also optionally at least one port for electrical communications with a processor/controller of the article 100 and/or the battery pack 106.

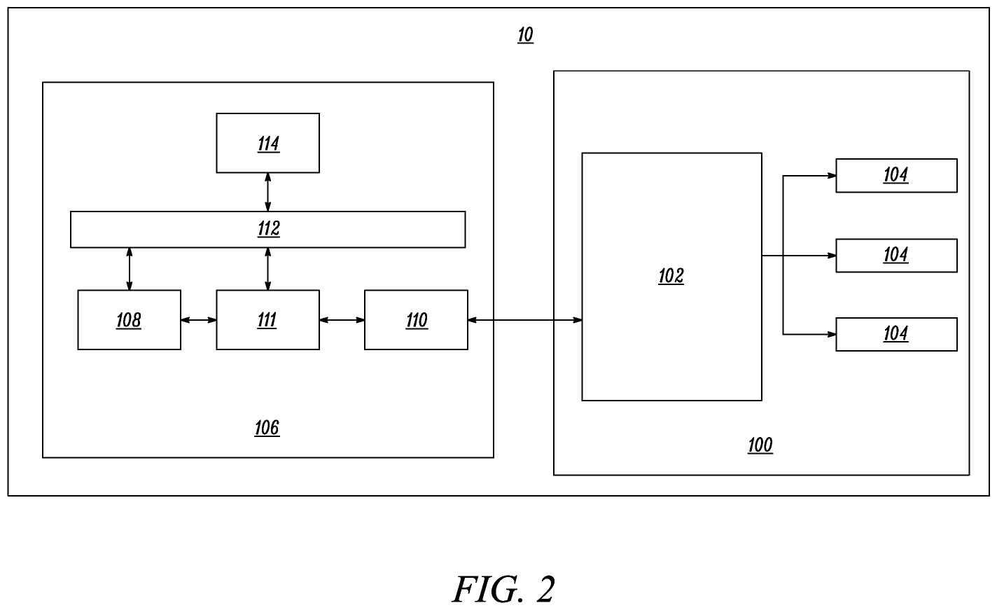

FIG. 2 illustrates a schematic block diagram of the PPE system 10 according to an embodiment of the present disclosure. As discussed above, the PPE system 10 includes the article 100 and the battery pack 106.

The battery pack 106 includes at least one battery 108. The at least one battery 108 is configured to power the one or more components 104 of the article 100. The at least one battery 108 may be a secondary battery, i.e., a rechargeable battery. The at least one battery 108 may be made up of a plurality of electrochemical cells. In some embodiments, the at least one battery 108 may be a lithium-ion battery.

The battery pack 106 further includes a plurality of electrical contacts 110 configured to electrically connect the at least one battery 108 to the one or more components 104 of the article 100 via the battery pack interface 102. The at least one battery 108 is configured to electrically power the one or more components 104 of the article 100 via the plurality of electrical contacts 110.

The battery pack 106 further includes a switching arrangement 111 electrically disposed between at least one electrical contact 110 from the plurality of electrical contacts 110 and the at least one battery 108. The switching arrangement 111 is configured to selectively electrically connect the at least one electrical contact 110 to the at least one battery 108 and selectively electrically disconnect the at least one electrical contact 110 from the at least one battery 108.

The switching arrangement 111 may include any suitable arrangement of electrical components that allows for selective electrical connection of the at least one electrical contact 110 to the at least one battery 108, and selective electrical disconnection of the at least one electrical contact 110 from the at least one battery 108. The switching arrangement 111 may include, for example, switches, reed switches, transistors, and the like.

The battery pack 106 further includes a battery controller 112 configured to control the switching arrangement 111 to electrically connect the at least one electrical contact 110 to the at least one battery 108. The battery controller 112 may be communicably coupled to the switching arrangement 111.

The battery controller 112 controls the switching arrangement 111 to electrically disconnect the at least one electrical contact 110 from the at least one battery 108 based on one or more predefined conditions so as to prevent corrosion of the plurality of electrical contacts 110 when a conductive liquid contacts the plurality of electrical contacts 110. In other words, the battery controller 112 controls the switching arrangement 111 to selectively allow flow of electric current from the at least one battery 108 to the at least one electrical contact 110 based on the one or more predefined conditions. In some embodiments, the one or more predefined conditions include at least one of a resonant frequency condition, a capacitance condition, an electromagnetic condition, and/or a mechanical condition. Various examples of the PPE system 10 will be described below that may utilize the resonant frequency condition, the capacitance condition, the electromagnetic condition, and the mechanical condition. It may be noted that the aforementioned conditions may be used independently or in conjunction with each other.

As a result, the plurality of electrical contacts 110 may not corrode when exposed to the conductive liquid (such as water) during cleaning, or when the battery pack 106 is not powering the one or more components 104 of the article 100. This may allow the battery pack 106 to be submersible in the conductive liquid.

In the illustrated embodiment of FIG. 2, the battery pack 106 further includes a motion detector 114 communicably connected to the battery controller 112. In some embodiments, the battery controller 112 is further configured control the motion detector 114 to detect a motion of the battery pack 106. In some embodiments, the motion detector 114 includes at least one of an accelerometer and a gyro sensor.

In some embodiments, the battery controller 112 is further configured to enter a low power (or a “sleep”) state after some time has elapsed with the battery pack 106 not in motion. This may reduce an amount of energy consumed by the battery controller 112 from the at least one battery 108 when the battery pack 106 is not in motion (for example, when the battery pack 106 is stored and not in use). If motion is then detected, the motion detector 114 can be configured to “wake-up” the battery controller 112.

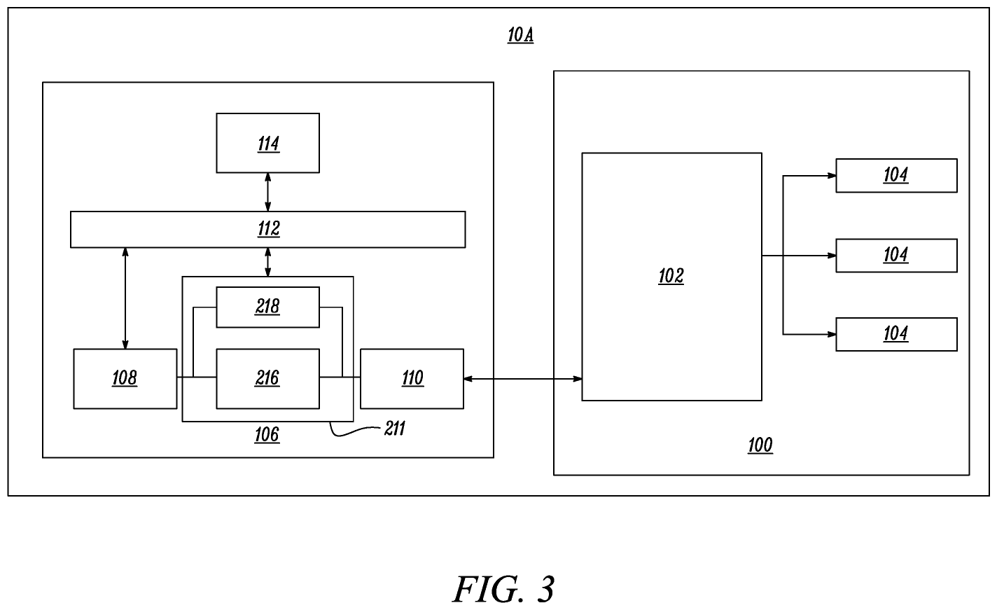

FIG. 3 illustrates a schematic block diagram of a PPE system 10A according to another embodiment of the present disclosure.

The PPE system 10A is similar to the PPE system 10 of FIG. 2, with like elements designated by like reference characters. Further, the PPE system 10A includes a switching arrangement 211 that is similar to the switching arrangement 111 of FIG. 2 in function (i.e., selectively electrically connecting the at least one electrical contact 110 to the at least one battery 108 and selectively electrically disconnecting the at least one electrical contact 110 from the at least one battery 108). However, the switching arrangement 211 has a specific configuration that is described hereinafter.

Specifically, in the illustrated embodiment of FIG. 3, the switching arrangement 211 includes a waterproof switch 216 and a transistor 218. The waterproof switch 216 is electrically disposed between the at least one electrical contact 110 and the at least one battery 108. The waterproof switch 216 is configured to electrically connect the at least one electrical contact 110 to the at least one battery 108 in a first mode and electrically disconnect the at least one electrical contact 110 from the at least one battery 108 in a second mode. The first mode of the waterproof switch 216 may correspond to an “on” state thereof, while the second mode of the waterproof switch 216 may correspond to an “off” state thereof.

The waterproof switch 216 may be a mechanical switch or a magnetically operated switch with a suitable design that prevents ingress of water therein. The waterproof switch 216 may conform to standards such as IPX5, IPX6, IPX7, or better. Therefore, the waterproof switch 216 may optimally function in presence of water. In some embodiments, the waterproof switch 216 is a reed switch. In some embodiments, the waterproof switch 216 is mounted internally to the battery pack 106, and thus requires no additional IPXX rating.

Further, the transistor 218 is electrically disposed between the at least one electrical contact 110 and the at least one battery 108 and in parallel to the waterproof switch 216. The transistor 218 is configured to electrically connect the at least one electrical contact 110 to the at least one battery 108 when switched on and electrically disconnect the at least one electrical contact 110 from the at least one battery 108 when switched off.

In some embodiments, upon physical connection of the battery pack 106 to the battery pack interface 102 of the article 100, the waterproof switch 216 mechanically or electromagnetically switches to the first mode. Further, the battery controller 112 is further configured to determine whether the waterproof switch 216 is in the first mode or the second mode. Further, in some embodiments, upon physical connection of the battery pack 106 to a battery charger (not shown), the waterproof switch 216 mechanically or electromagnetically switches to the first mode.

In some embodiments, upon determining that the waterproof switch 216 is in the first mode, the battery controller 112 is further configured to determine whether the one or more components 104 of the article 100 are receiving power from the at least one battery 108 via the plurality of electrical contacts 110. In some examples, upon determining that the waterproof switch 216 is in the first mode, the battery controller 112 is further configured to determine whether the at least one battery 108 is being charged via the battery charger.

In some embodiments, upon determining that the one or more components 104 of the article 100 are receiving power from the at least one battery 108 via the plurality of electrical contacts 110, the battery controller 112 controls the switching arrangement 211 to switch on the transistor 218 in order to bypass the waterproof switch 216 and electrically connect the at least one electrical contact 110 to the at least one battery 108 regardless of the waterproof switch 216 being in the first mode or the second mode.

Further, in some embodiments, upon determining that the one or more components 104 of the article 100 are not receiving power from the at least one battery 108 via the plurality of electrical contacts 110, the battery controller 112 controls the switching arrangement 211 to switch off the transistor 218.

Bypassing the waterproof switch 216 with the transistor 218 may prevent inadvertent disconnections or potential disruptions during use of the PPE system 10A in environments having strong magnetic fields. Bypassing the waterproof switch 216 with the transistor 218 may further prevent inadvertent disconnections or potential disruptions during use of the PPE system 10A if the PPE system 10A experiences strong impacts or if the PPE system 10A is accidentally dropped. This approach may be simple and economical.

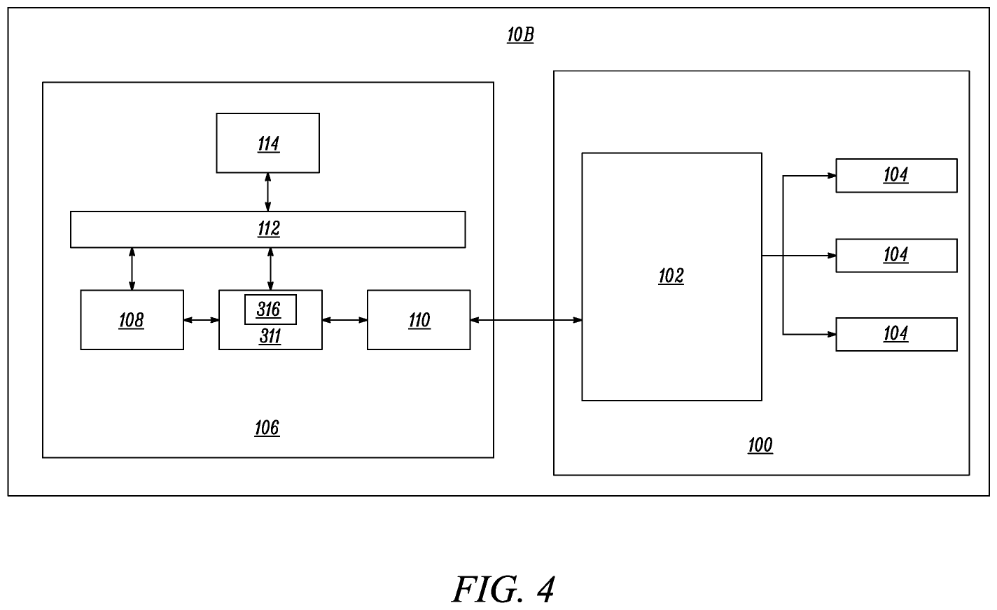

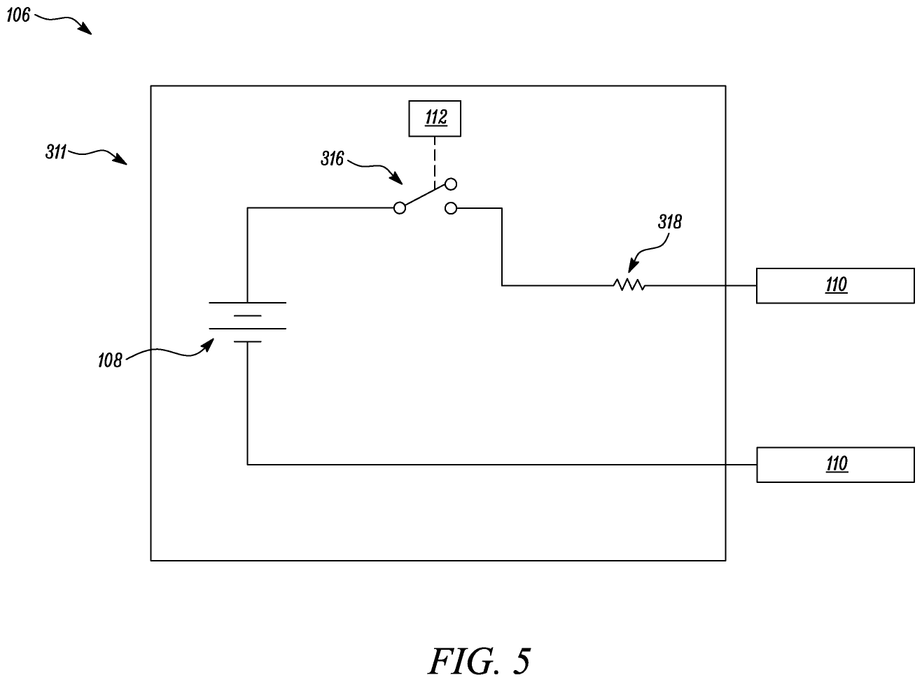

FIGS. 4-6 address solutions to intermittent charge damage. FIG. 4 illustrates a schematic block diagram of a PPE system 10B according to another embodiment of the present disclosure. The PPE system 10B is similar to the PPE system 10 of FIG. 2, with like elements designated by like reference characters. Further, the PPE system 10B includes a switching arrangement 311 that is similar to the switching arrangement 111 of FIG. 2 in function (i.e., selectively electrically connecting the at least one electrical contact 110 to the at least one battery 108 and selectively electrically disconnecting the at least one electrical contact 110 from the at least one battery 108). However, the switching arrangement 311 has a specific configuration that is described hereinafter with further reference to FIG. 5. Specifically, in the illustrated embodiment of FIG. 4, the switching arrangement 311 includes a switch 316 that is controllable by the battery controller 112.

Referring to FIGS. 4 and 5, in some embodiments, the battery controller 112 is configured to control the switching arrangement 311 to electrically connect the at least one electrical contact 110 to the at least one battery 108 during a plurality of recurring time durations spaced apart by a plurality of intermediate time durations. Furthermore, the battery controller 112 is configured to control the switching arrangement 311 to electrically disconnect the at least one electrical contact 110 from the at least one battery 108 during the plurality of intermediate time durations.

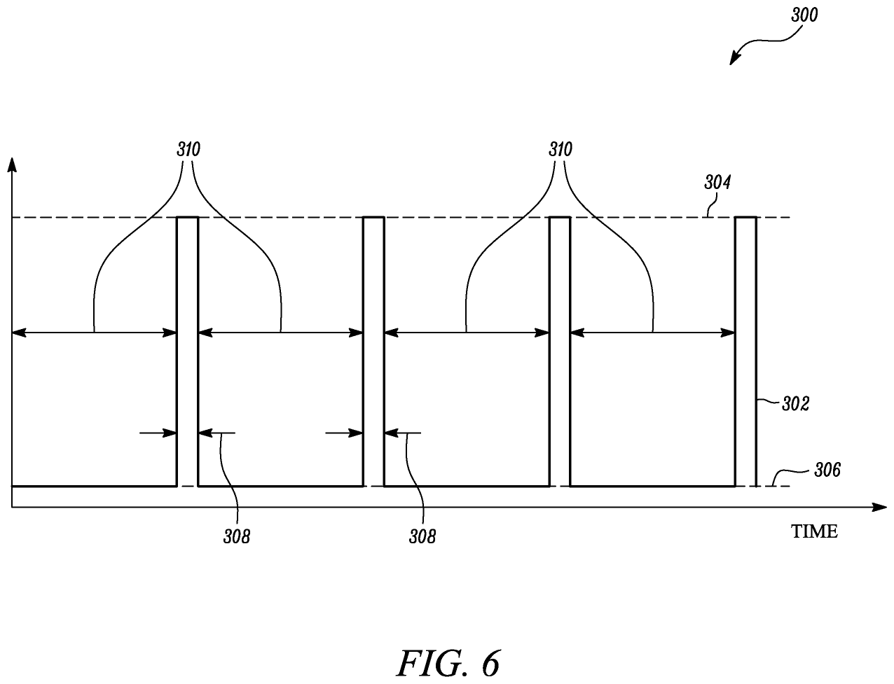

For example, the battery controller 112 may control the switch 316 of the switching arrangement 311 to electrically connect the at least one electrical contact 110 to the at least one battery 108 through a current limiting means 318 (e.g., a resistor) during the plurality of recurring time durations spaced apart by the plurality of intermediate time durations (by switching on the switch 316 intermittently). Furthermore, the battery controller 112 may control the switch 316 of the switching arrangement 311 to electrically disconnect the at least one electrical contact 110 from the at least one battery 108 during the plurality of intermediate time durations (by switching off the switch 316 intermittently). The PPE system 10B will be further explained in detail with the reference to FIG. 6.

FIG. 6 illustrates a graph 300 depicting an exemplary electrical connection of the at least one electrical contact 110 to the to the at least one battery 108 and an electrical disconnection of the at least one electrical contact 110 from the at least one battery 108 with respect to time.

Referring to FIGS. 4-6, electrical connection (i.e., an electrically connected state) of the at least one electrical contact 110 to the to the at least one battery 108 is depicted by a first line 304 (shown by dashed lines), and electrical disconnection (i.e., an electrically disconnected state) of the at least one electrical contact 110 from the at least one battery 108 is depicted by a second line 306 (shown by dashed lines) on an axis of ordinates (y-axis). Time is represented on an axis of abscissas (x-axis).

The graph 300 further includes a curve 302 depicting when the at least one electrical contact 110 is electrically connected to the at least one battery 108 and when the at least one electrical contact 110 is electrically disconnected to the at least one battery 108.

As depicted by the curve 302, in some embodiments, the battery controller 112 is configured to control the switching arrangement 311 to electrically connect the at least one electrical contact 110 to the at least one battery 108 during a plurality of recurring time durations 308 spaced apart by a plurality of intermediate time durations 310. The plurality of recurring time durations 308 may be shorter than the plurality of intermediate time durations 310. For example, each of the plurality of intermediate time durations 310 may be greater than or equal to two times of each of the plurality of recurring time durations 308.

Further, as depicted by the curve 302, in some embodiments, the battery controller 112 is configured to control the switching arrangement 311 to electrically disconnect the at least one electrical contact 110 from the at least one battery 108 during the plurality of intermediate time durations 310.

In some embodiments, the battery controller 112 is further configured to detect if there is communication between the article 100 and the at least one battery 108 during the plurality of recurring time durations 308. In some examples, the battery controller 112 is further configured to determine whether the at least one battery 108 is being charged via the battery charger.

In some embodiments, upon detecting communication between the article 100 and the at least one battery 108 during any one of the plurality of recurring time durations 308, the battery controller 112 controls the switching arrangement 111 to electrically connect the at least one battery 108 to the at least one electrical contact 110 until the one or more components 104 of the article 100 stop receiving power from the at least one battery 108 via the plurality of electrical contacts 110. In some examples, upon detecting communication between the battery charger and the at least one battery 108 during any one of the plurality of recurring time durations 308, the battery controller 112 controls the switching arrangement 111 to electrically connect the at least one battery 108 to the at least one electrical contact 110 at least until the at least one battery 108 is fully charged.

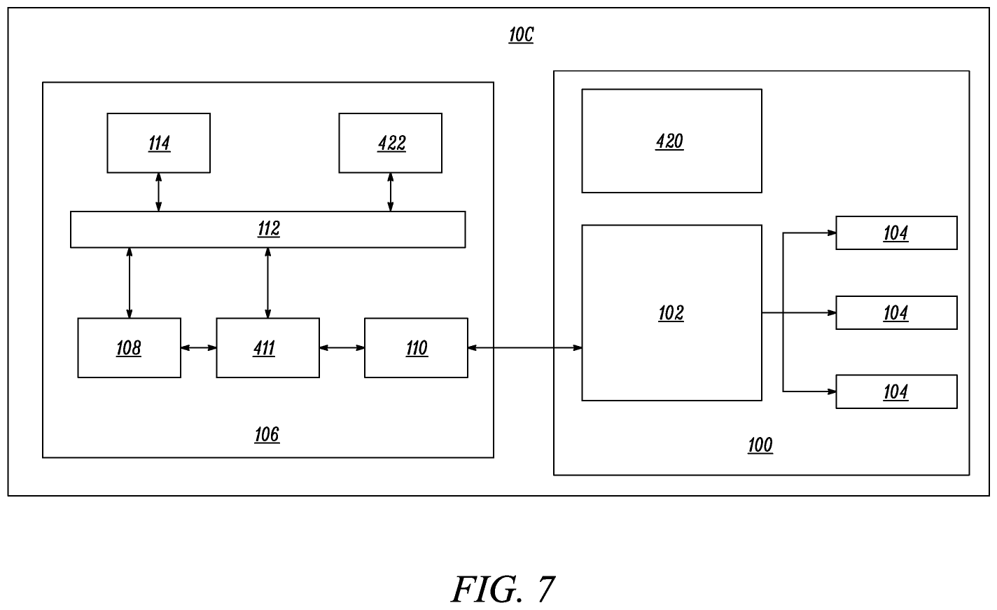

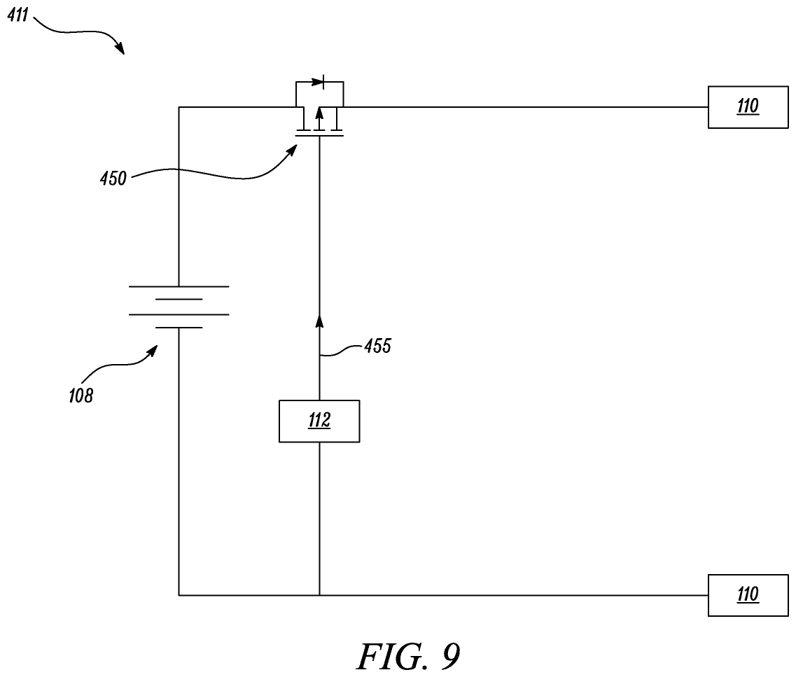

FIG. 7 illustrates a schematic block diagram of a PPE system 10C according to another embodiment of the present disclosure, which may be described as frequency shift detection of a safety device or tuned circuit detection. The PPE system 10C is similar to the PPE system 10 of FIG. 2, with like elements designated by like reference characters. Further, the PPE system 10C includes a switching arrangement 411 that is similar to the switching arrangement 111 of FIG. 2 in function (i.e., selectively electrically connecting the at least one electrical contact 110 to the at least one battery 108 and selectively electrically disconnecting the at least one electrical contact 110 from the at least one battery 108). However, the switching arrangement 411 has a specific configuration that is described hereinafter with further reference to FIG. 9. Further, the article 100 and the battery pack 106 of the PPE system 10C include one or more additional components as compared to the PPE system 10 of FIG. 2.

Specifically, in the illustrated embodiment of FIG. 7, the article 100 includes an article circuit 420 disposed proximal to the battery pack interface 102. The article circuit 420 is tuned to a predefined frequency. Further, in the illustrated embodiment of FIG. 7, the battery pack 106 includes a frequency measurement circuit 422 communicably coupled to the battery controller 112.

The frequency measurement circuit 422 may be controlled to measure a frequency of proximal circuits. In some embodiments, the battery controller 112 is configured to control the frequency measurement circuit 422 to detect a frequency of the article circuit 420. In other words, if the article circuit 420 is present in a close proximity (e.g., less than 10 centimeters) of the frequency measurement circuit 422, the predefined frequency of the article circuit 420 may be detected. Detection of the predefined frequency of the article circuit 420 may therefore be indicative of the battery pack 106 being connected to the battery pack interface 102 of the article 100. Further, the article circuit 420 may be included in the battery charger, such that detection of the predefined frequency of the article circuit 420 may be indicative of the battery pack 106 being connected to the battery charger.

In some embodiments, if the battery controller 112 detects, via the frequency measurement circuit 422, the article circuit 420 of the article 100 based on the predefined frequency, the battery controller 112 controls the switching arrangement 411 to electrically connect the at least one electrical contact 110 to the at least one battery 108.

Further, in some embodiments, if the battery controller 112 does not detect, via the frequency measurement circuit 422, the article circuit 420 of the article 400, the battery controller 112 controls the switching arrangement 411 to electrically disconnect the at least one electrical contact 110 from the at least one battery 108.

As a result, the battery controller 112 may connect the at least one electrical contact 110 to the at least one battery 108 only when the battery pack 106 is connected to the battery pack interface 102 of the article 100.

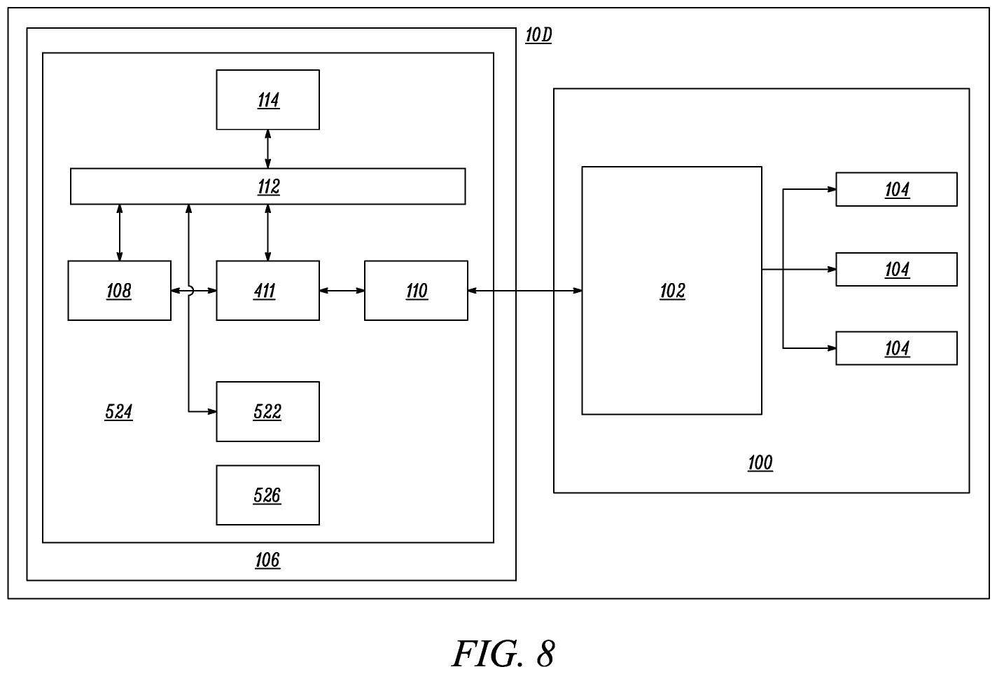

Detection of liquid by a shift in resonant frequency is exemplified in FIG. 8. FIG. 8 illustrates a schematic block diagram of a PPE system 10D according to another embodiment of the present disclosure. The PPE system 10D is similar to the PPE system 10 of FIG. 2, with like elements designated by like reference characters. However, the PPE system 10D includes the switching arrangement 411 (described with reference to FIG. 9 below). Further, the battery pack 106 of the PPE system 10D includes one or more additional components as compared to the PPE system 10 of FIG. 2.

In the illustrated embodiment of FIG. 8, the battery pack 106 includes a housing 524 and a circuit 526 disposed proximal to an exterior of the housing 524. Specifically, the circuit 526 may be disposed interior to the housing 524. The circuit 526 is tuned to a predefined frequency.

In the illustrated embodiment of FIG. 8, the battery pack 106 further includes a frequency measurement circuit 522 disposed interior to the housing 524 and communicably coupled to the battery controller 112. Further, the battery controller 112 is configured to control the frequency measurement circuit 522 to detect a frequency of the circuit 526.

The frequency measurement circuit 522 may be controlled to detect a frequency shift from the predefined frequency of the circuit 526, for example, due to a presence of a liquid. The frequency measurement circuit 522 may therefore be controlled to detect the frequency shift indicative of the presence of the liquid.

In some embodiments, if the battery controller 112 detects, via the frequency measurement circuit 522, that the frequency of the circuit 526 deviates from the predefined frequency by less than a predefined frequency shift, then the battery controller 112 controls the switching arrangement to electrically connect the at least one electrical contact 110 to the at least one battery 108.

In some cases, the predefined frequency shift may be from 1% to 5% of the predefined frequency. Deviation of the frequency of the circuit 526 by less than the predefined frequency shift from the predefined frequency may indicate an absence of the liquid. For example, if the predefined frequency shift is less than 1% of the predefined frequency, the battery controller 112 may determine that the liquid is not proximally present.

In some embodiments, if the battery controller 112 detects, via the frequency measurement circuit 522, that the frequency of the circuit 526 deviates from the predefined frequency by more than the predefined frequency shift, then the battery controller 112 controls the switching arrangement 411 to electrically disconnect the at least one electrical contact 110 from the at least one battery 108. Deviation of the frequency of the circuit 526 by more than the predefined frequency shift from the predefined frequency may indicate a presence of the liquid.

FIG. 9 illustrates a schematic circuit diagram of the switching arrangement 411 according to an embodiment of the present disclosure. This provides control of the transistors to turn off the outputs.

In the illustrated embodiment of FIG. 9, the switching arrangement 411 includes a transistor 450 communicably coupled to the battery controller 112. The transistor 450 is switchable between an on state and an off state based on a control signal 455 from the battery controller 112.

In some embodiments, the battery controller 112 is further configured to switch the transistor 450 to the on state in order to allow flow of electric current from the at least one battery 108 to the at least one electrical contact 110. The battery controller 112 is further configured to switch the transistor 450 to the off state in order to prevent flow of electric current from the at least one battery 108 to the at least one electrical contact 110.

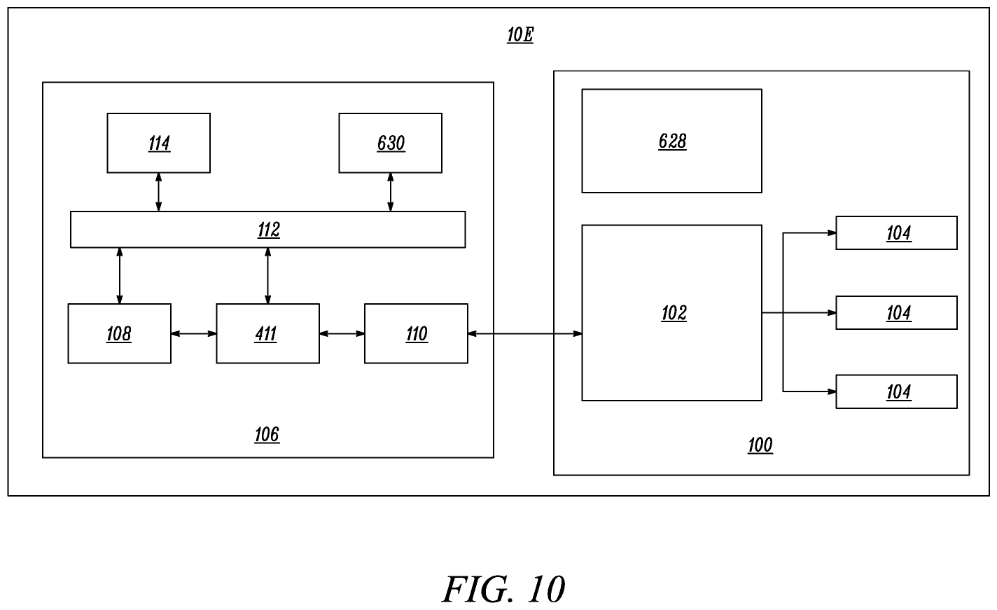

FIG. 10 illustrates capacitive detection of liquids with a schematic block diagram of a PPE system 10E according to another embodiment of the present disclosure. The PPE system 10E is similar to the PPE system 10 of FIG. 2, with like elements designated by like reference characters. However, the PPE system 10E includes the switching arrangement 411 as described with reference to FIG. 9 above. Further, the article 100 and the battery pack 106 of the PPE system 10E include one or more additional components as compared to the PPE system 10 of FIG. 2.

In the illustrated embodiment of FIG. 10, the article 100 further includes a conductive object 628 disposed proximal to the battery pack interface 102. In some embodiments, the conductive object 628 may include a metal foil. Furthermore, in the illustrated embodiment of FIG. 10, the battery pack 106 further includes a capacitive sensor 630 communicably coupled to the battery controller 112. In some examples, the conductive object 628 may further be disposed within the battery charger.

In some embodiments, the battery controller 112 is configured to control the capacitive sensor 630 to detect a proximal presence or absence of the conductive object 628 via capacitive coupling.

Further, in some embodiments, the battery controller 112 controls the switching arrangement 411 to electrically connect the at least one electrical contact 110 to the at least one battery 108 or electrically disconnect the at least one electrical contact 110 from the at least one battery 108 based on the proximal presence or absence of the conductive object 628.

Specifically, in some embodiments, if the battery controller 112 detects the proximal presence the conductive object 628 via the capacitive sensor 630, the battery controller 112 may electrically connect the at least one electrical contact 110 to the at least one battery 108. Further, in some embodiments, if the battery controller 112 does not detect the proximal presence of the conductive object 628 via the capacitive sensor 630, the battery controller 112 may electrically disconnect the at least one electrical contact 110 from the at least one battery 108.

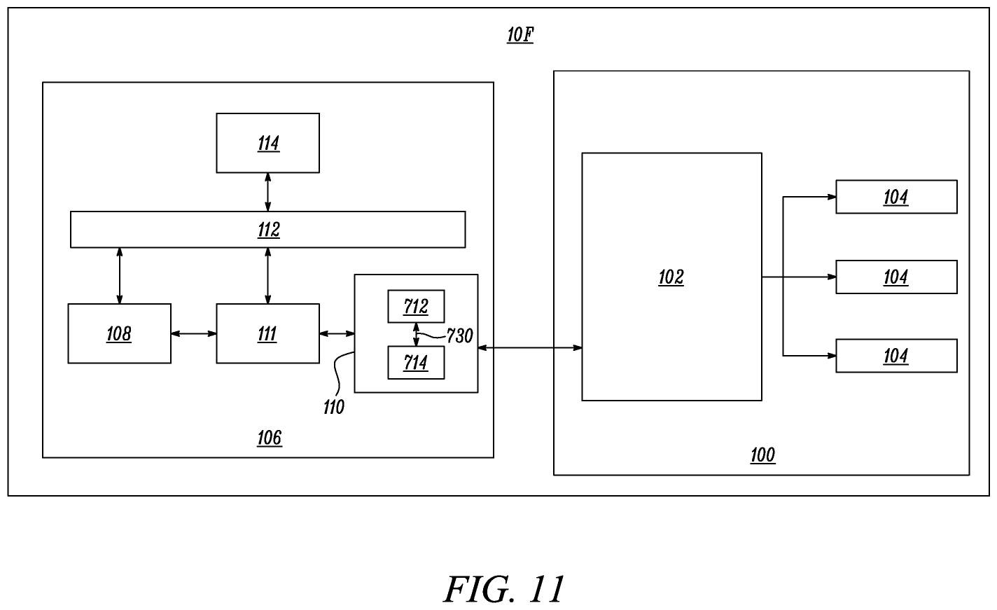

FIG. 11 illustrates a net neutral charge-transfer measurement of circuit capacitance in a schematic block diagram of a PPE system 10F according to another embodiment of the present disclosure. The PPE system 10F is similar to the PPE system 10 of FIG. 2, with like elements designated by like reference characters. However, the battery pack 106 of the PPE system 10F includes a specific arrangement of the plurality of electrical contacts 110.

Specifically, in the illustrated embodiment of FIG. 11, the plurality of electrical contacts 110 includes a positive electrical contact 712 and a negative electrical contact 714. Further, in the illustrated embodiment of FIG. 11, the battery controller 112 is configured to provide an alternating signal 730 between the positive electrical contact 712 and the negative electrical contact 714. The alternating signal 730 may be, for example, a sinusoidal electrical signal.

In the illustrated embodiment of FIG. 11, the battery controller 112 is further configured to determine an effective capacitance between the positive electrical contact 712 and the negative electrical contact 714 due to the alternating signal 730.

In some embodiments, the battery controller 112 is further configured to determine whether the battery pack 106 is electrically connected to the battery pack interface 102 based on the effective capacitance. For example, the effective capacitance may have a greater magnitude when battery pack 106 is connected to the article 100. In another example, the effective capacitance may have a greater magnitude when battery pack 106 is connected to the battery charger.

In some embodiments, if the battery controller 112 detects that the battery pack 106 is electrically connected to the battery pack interface 102 based on the effective capacitance, the battery controller 112 controls the switching arrangement 111 to electrically connect the at least one electrical contact 110 (i.e., the positive electrical contact 712 and/or the negative electrical contact 714) to the at least one battery 108.

In some embodiments, if the battery controller 112 detects that the battery pack 106 is not electrically connected to the battery pack interface 102 based on the effective capacitance, the battery controller 112 controls the switching arrangement 111 to electrically disconnect the at least one electrical contact 110 (i.e., the positive electrical contact 712 and/or the negative electrical contact 714) from the at least one battery 108.

In any of the above described embodiments, it is understood that sacrificial electrical contacts could also be used, which are separate from the contacts used for the primary function of the device, for liquid detection. Corrosion or tarnishing of such sacrificial electrical contacts would not hinder the primary function of the device, and would only be used detect the liquid.

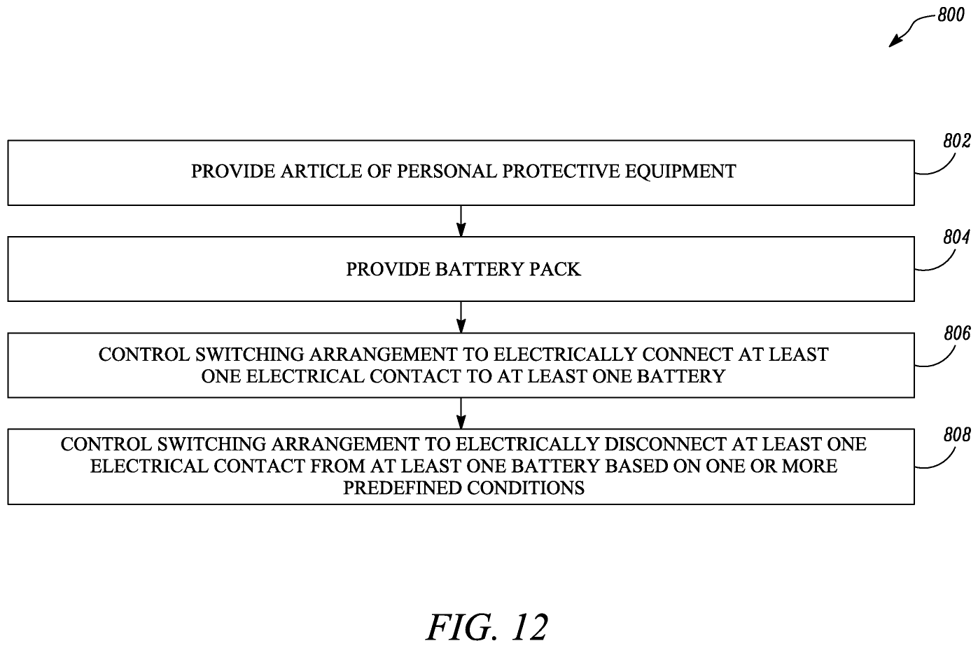

FIG. 12 illustrates a flowchart depicting various steps of a method 800 according to an embodiment of the present disclosure. In some embodiments, the method 800 may be implemented by the PPE system 10 of FIG. 2, the PPE system 10A of FIG. 3, the PPE system 10B of FIG. 4, the PPE system 10C of FIG. 7, the PPE system 10D of FIG. 9, the PPE system 10E of FIG. 10, and the PPE system 10F of FIG. 11. One or more steps of the method 800 may be performed by the battery controller 112 (shown in FIG. 2).

At step 802, the method 800 includes providing an article of PPE. The article of PPE includes a battery pack interface and one or more components that are electrically powered and configured to receive electrical power via the battery pack interface. For example, the method 800 may include providing the article 100 (shown in FIG. 2).

At step 804, the method 800 further includes providing a battery pack. The battery pack is configured to physically and electrically connect to and disconnect from the battery pack interface of the article of PPE. The battery pack includes at least one battery and a plurality of electrical contacts configured to electrically connect the at least one battery to the one or more components of the article of PPE via the battery pack interface. The at least one battery is configured to electrically power the one or more components of the article of PPE via the plurality of electrical contacts. The battery pack further includes a switching arrangement electrically disposed between at least one electrical contact from the plurality of electrical contacts and the at least one battery. The switching arrangement is configured to selectively electrically connect the at least one electrical contact to the at least one battery and selectively electrically disconnect the at least one electrical contact from the at least one battery. For example, the method 800 may further include providing the battery pack 106 (shown in FIG. 2).

At step 806, the method 800 further includes controlling the switching arrangement to electrically connect the at least one electrical contact to the at least one battery. For example, referring to FIG. 2, the method 800 may further include controlling the switching arrangement 111 to electrically connect the at least one electrical contact 110 to the at least one battery 108.

At step 808, the method 800 further includes controlling the switching arrangement to electrically disconnect the at least one electrical contact from the at least one battery based on one or more predefined conditions so as to prevent corrosion of the plurality of electrical contacts when a conductive liquid contacts the plurality of electrical contacts. For example, referring to FIG. 2, the method 800 may include controlling the switching arrangement 111 to electrically disconnect the at least one electrical contact 110 from the at least one battery 108 based on the one or more predefined conditions so as to prevent corrosion of the plurality of electrical contacts 110 when the conductive liquid contacts the plurality of electrical contacts 110.

In some embodiments, the one or more predefined conditions include at least one of a resonant frequency condition, a capacitance condition, an electromagnetic condition, and a mechanical condition.

In some embodiments, the switching arrangement includes a waterproof switch electrically disposed between the at least one electrical contact and the at least one battery. The waterproof switch is configured to electrically connect the at least one electrical contact to the at least one battery in a first mode and electrically disconnect the at least one electrical contact from the at least one battery in a second mode. Upon physical connection of the battery pack to the battery pack interface of the article of PPE, the waterproof switch mechanically or electromagnetically switches to the first mode. In some embodiments, the switching arrangement further includes a transistor electrically disposed between the at least one electrical contact and the at least one battery and in parallel to the waterproof switch. The transistor is configured to electrically connect the at least one electrical contact to the at least one battery when switched on and electrically disconnect the at least one electrical contact from the at least one battery when switched off. In some embodiments, the method 800 further includes determining whether the waterproof switch is in the first mode or the second mode. In some embodiments, the method 800 further includes, upon determining that the waterproof switch is in the first mode, determining whether the one or more components of the article of PPE are receiving power from the at least one battery via the plurality of electrical contacts. In some embodiments, the method 800 further includes, upon determining that the one or more components of the article of PPE are receiving power from the at least one battery via the plurality of electrical contacts, controlling the switching arrangement to switch on the transistor in order to bypass the waterproof switch and electrically connect the at least one electrical contact to the at least one battery regardless of the waterproof switch being in the first mode or the second mode. In some embodiments, the method 800 further includes, upon determining that the one or more components of the article of PPE are not receiving power from the at least one battery via the plurality of electrical contacts, controlling the switching arrangement to switch off the transistor.

For example, referring to FIG. 3, the method 800 may include determining whether the waterproof switch 216 is in the first mode or the second mode. The method 800 may further include, upon determining that the waterproof switch 216 is in the first mode, determining whether the one or more components 104 of the article 100 are receiving power from the at least one battery 108 via the plurality of electrical contacts 110. The method 800 may further include, upon determining that the one or more components 104 of the article 100 are receiving power from the at least one battery 108 via the plurality of electrical contacts 110, controlling the switching arrangement 211 to switch on the transistor 218 in order to bypass the waterproof switch 216 and electrically connect the at least one electrical contact 110 to the at least one battery 108 regardless of the waterproof switch 216 being in the first mode or the second mode. The method 800 may further include, upon determining that the one or more components 104 of the article 100 are not receiving power from the at least one battery 108 via the plurality of electrical contacts 110, controlling the switching arrangement 211 to switch off the transistor 218.

In some embodiments, the method 800 further includes controlling the switching arrangement to electrically connect the at least one electrical contact to the at least one battery during a plurality of recurring time durations spaced apart by a plurality of intermediate time durations. In some embodiments, the method 800 further includes controlling the switching arrangement to electrically disconnect the at least one electrical contact from the at least one battery during the plurality of intermediate time durations. In some embodiments, the method 800 further includes detecting if there is communication between the article of PPE and the at least one battery during the plurality of recurring time durations. In some embodiments, the method 800 further includes, upon detecting communication between the article of PPE and the at least one battery during any one of the plurality of recurring time durations, controlling the switching arrangement to electrically connect the at least one battery to the at least one electrical contact until the one or more components of the article of PPE stop receiving power from the at least one battery via the plurality of electrical contacts.

For example, referring to FIGS. 4-6, the method 800 may further include controlling the switching arrangement 311 to electrically connect the at least one electrical contact 110 to the at least one battery 108 during the plurality of recurring time durations 308 spaced apart by the plurality of intermediate time durations 310. The method 800 may further include controlling the switching arrangement 311 to electrically disconnect the at least one electrical contact 110 from the at least one battery 108 during the plurality of intermediate time durations 310. The method 800 may further include detecting if there is communication between the article 100 and the at least one battery 108 during the plurality of recurring time durations 308. The method 800 may further include, upon detecting communication between the article 100 and the at least one battery 108 during any one of the plurality of recurring time durations 308, controlling the switching arrangement 311 to electrically connect the at least one battery 108 to at least one electrical contact 110 until the one or more components 104 of the article 100 stop receiving power from the at least one battery 108 via the plurality of electrical contacts 110.

In some embodiments, the article of PPE further includes an article circuit disposed proximal to the battery pack interface and tuned to a predefined frequency, and the battery pack further includes a frequency measurement circuit. In some embodiments, the method 800 further includes controlling the frequency measurement circuit to detect a frequency of the article circuit. In some embodiments, the method 800 further includes controlling the switching arrangement to electrically connect the at least one electrical contact to the at least one battery upon detection, via the frequency measurement circuit, of the article of PPE based on the predefined frequency. In some embodiments, the method 800 further includes controlling the switching arrangement to electrically disconnect the at least one electrical contact from the at least one battery if the article circuit of the article of PPE is not detected via the frequency measurement circuit.

For example, referring to FIG. 7, the method 800 may include controlling the frequency measurement circuit 422 to detect the frequency of the article circuit 420. The method 800 may further include controlling the switching arrangement 411 to electrically connect the at least one electrical contact 110 to the at least one battery 108 upon detection, via the frequency measurement circuit 422, of the article 100 based on the predefined frequency. The method 800 may further include controlling the switching arrangement 411 to electrically disconnect the at least one electrical contact 110 from the at least one battery 108 if the article circuit 420 of the article 100 is not detected via the frequency measurement circuit 422.

In some embodiments, the battery pack further includes a housing and a circuit disposed proximal to an exterior of the housing, and the circuit is tuned to a predefined frequency. In some embodiments, the battery pack further includes a frequency measurement circuit disposed interior to the housing. In some embodiments, the method 800 further includes controlling the frequency measurement circuit to detect a frequency of the circuit. In some embodiments, the method 800 further includes controlling the switching arrangement to connect the at least one electrical contact to the at least one battery if the frequency of the circuit deviates from the predefined frequency by less than a predefined frequency shift. In some embodiments, the method 800 further includes controlling the switching arrangement to electrically disconnect the at least one electrical contact from the at least one battery if the frequency of the circuit deviates from the predefined frequency by more than the predefined frequency shift.

For example, referring to FIG. 9, the method 800 may further include controlling the frequency measurement circuit 522 to detect the frequency of the circuit 526. The method 800 may further include controlling the switching arrangement 411 to connect the at least one electrical contact 110 to the at least one battery 108 if the frequency of the circuit 526 deviates from the predefined frequency by less than the predefined frequency shift. The method 800 may further include controlling the switching arrangement 411 to electrically disconnect the at least one electrical contact 110 from the at least one battery 108 if the frequency of the circuit 526 deviates from the predefined frequency by more than the predefined frequency shift.

In some embodiments, the article of PPE further includes a conductive object disposed proximal to the battery pack interface. In some embodiments, the battery pack further includes a capacitive sensor communicably coupled to the battery controller. In some embodiments, the method 800 further includes controlling the capacitive sensor to detect a proximal presence or absence of the conductive object via capacitive coupling. In some embodiments, the method 800 further includes controlling the switching arrangement to electrically connect the at least one electrical contact to the at least one battery or electrically disconnect the at least one electrical contact from the at least one battery based on the proximal presence or absence of the conductive object.

For example, referring to FIG. 10, the method 800 may further include controlling the capacitive sensor 630 to detect the proximal presence or absence of the conductive object 628 via capacitive coupling. The method 800 may further include controlling the switching arrangement 411 to electrically connect the at least one electrical contact 110 to the at least one battery 108 or electrically disconnect the at least one electrical contact 110 from the at least one battery 108 based on the proximal presence or absence of the conductive object 628.

In some embodiments, the plurality of electrical contacts includes a positive electrical contact and a negative electrical contact. In some embodiments, the method 800 further includes providing an alternating signal between the positive electrical contact and the negative electrical contact. In some embodiments, the method 800 further includes determining an effective capacitance between the positive electrical contact and the negative electrical contact due to the alternating signal. In some embodiments, the method 800 further includes determining whether the battery pack is electrically connected to the battery pack interface based on the effective capacitance. In some embodiments, the method 800 further includes controlling the switching arrangement to electrically connect the at least one electrical contact to the at least one battery upon determining that the battery pack is electrically connected to the battery pack interface based on the effective capacitance. In some embodiments, the method 800 further includes controlling the switching arrangement to electrically disconnect the at least one electrical contact from the at least one battery upon determining that the battery pack is not electrically connected to the battery pack interface based on the effective capacitance.

For example, referring to FIG. 11, the method 800 may further include providing the alternating signal 730 between the positive electrical contact 712 and the negative electrical contact 714. The method 800 may further include determining the effective capacitance between the positive electrical contact 712 and the negative electrical contact 714 due to the alternating signal 730. The method 800 may further include determining whether the battery pack 106 is electrically connected to the battery pack interface 102 based on the effective capacitance. The method 800 may further include controlling the switching arrangement 111 to electrically connect the at least one electrical contact 110 to the at least one battery 108 upon determining that the battery pack 106 is electrically connected to the battery pack interface 102 based on the effective capacitance. The method 800 may further include controlling the switching arrangement 111 to electrically disconnect the at least one electrical contact 110 from the at least one battery 108 upon determining that the battery pack 106 is not electrically connected to the battery pack interface 102 based on the effective capacitance.

It is to be recognized that depending on the example, certain acts or events of any of the methods described herein can be performed in a different sequence, may be added, merged, or left out altogether (e.g., not all described acts or events are necessary for the practice of the method).

Various examples have been described. These and other examples are within the scope of the following claims.

1. A personal protective equipment (PPE) system, the PPE system comprising:
an article of PPE comprising:
a battery pack interface; and
one or more components that are electrically powered and configured to receive electrical power via the battery pack interface; and
a battery pack configured to physically and electrically connect to and disconnect from the battery pack interface of the article of PPE, the battery pack comprising:
at least one battery;
a plurality of electrical contacts configured to electrically connect the at least one battery to the one or more components of the article of PPE via the battery pack interface, wherein the at least one battery is configured to electrically power the one or more components of the article of PPE via the plurality of electrical contacts;
a switching arrangement electrically disposed between at least one electrical contact from the plurality of electrical contacts and the at least one battery, wherein the switching arrangement is configured to selectively electrically connect the at least one electrical contact to the at least one battery and selectively electrically disconnect the at least one electrical contact from the at least one battery; and
a battery controller configured to control the switching arrangement to electrically connect the at least one electrical contact to the at least one battery, wherein the battery controller controls the switching arrangement to electrically disconnect the at least one electrical contact from the at least one battery when the article of PPE is not in use based on one or more predefined conditions so as to prevent corrosion of the plurality of electrical contacts when a conductive liquid contacts the plurality of electrical contacts.

2. The PPE system of claim 1, wherein the switching arrangement comprises:
a waterproof switch electrically disposed between the at least one electrical contact and the at least one battery, wherein the waterproof switch is configured to electrically connect the at least one electrical contact to the at least one battery in a first mode and electrically disconnect the at least one electrical contact from the at least one battery in a second mode, wherein, upon physical connection of the battery pack to the battery pack interface of the article of PPE, the waterproof switch mechanically or electromagnetically switches to the first mode; and
a transistor electrically disposed between the at least one electrical contact and the at least one battery and in parallel to the waterproof switch, wherein the transistor is configured to electrically connect the at least one electrical contact to the at least one battery when switched on and electrically disconnect the at least one electrical contact from the at least one battery when switched off;
wherein the battery controller is further configured to determine whether the waterproof switch is in the first mode or the second mode;
wherein, upon determining that the waterproof switch is in the first mode, the battery controller is further configured to determine whether the one or more components of the article of PPE are receiving power from the at least one battery via the plurality of electrical contacts; and
wherein:
upon determining that the one or more components of the article of PPE are receiving power from the at least one battery via the plurality of electrical contacts, the battery controller controls the switching arrangement to switch on the transistor in order to bypass the waterproof switch and electrically connect the at least one electrical contact to the at least one battery regardless of the waterproof switch being in the first mode or the second mode; and
upon determining that the one or more components of the article of PPE are not receiving power from the at least one battery via the plurality of electrical contacts, the battery controller controls the switching arrangement to switch off the transistor.

3. The PPE system of claim 2, wherein the waterproof switch is a reed switch.

4. The PPE system of claim 1, wherein the battery controller is further configured to control the switching arrangement to electrically connect the at least one electrical contact to the at least one battery during a plurality of recurring time durations spaced apart by a plurality of intermediate time durations, wherein the battery controller is further configured to control the switching arrangement to electrically disconnect the at least one electrical contact from the at least one battery during the plurality of intermediate time durations, wherein the battery controller is further configured to detect if there is communication between the article of PPE and the at least one battery during the plurality of recurring time durations, and wherein, upon detecting communication between the article of PPE and the at least one battery during any one of the plurality of recurring time durations, the battery controller controls the switching arrangement to electrically connect the at least one battery to the at least one electrical contact until the one or more components of the article of PPE stop receiving power from the at least one battery via the plurality of electrical contacts.

5. The PPE system of claim 1, wherein the article of PPE further comprises an article circuit disposed proximal to the battery pack interface and tuned to a predefined frequency, wherein the battery pack further comprises a frequency measurement circuit communicably coupled to the battery controller, wherein the battery controller is configured to control the frequency measurement circuit to detect a frequency of the article circuit; and
wherein:
if the battery controller detects, via the frequency measurement circuit, the article circuit of the article of PPE based on the predefined frequency, the battery controller controls the switching arrangement to electrically connect the at least one electrical contact to the at least one battery; and
if the battery controller does not detect, via the frequency measurement circuit, the article circuit of the article of PPE, the battery controller controls the switching arrangement to electrically disconnect the at least one electrical contact from the at least one battery.

6. The PPE system of claim 1, wherein the battery pack further comprises a housing and a circuit disposed proximal to an exterior of the housing, wherein the circuit is tuned to a predefined frequency, wherein the battery pack further comprises a frequency measurement circuit disposed interior to the housing and communicably coupled to the battery controller, wherein the battery controller is configured to control the frequency measurement circuit to detect a frequency of the circuit; and
wherein:
if the battery controller detects, via the frequency measurement circuit, that the frequency of the circuit deviates from the predefined frequency by less than a predefined frequency shift, then the battery controller controls the switching arrangement to electrically connect the at least one electrical contact to the at least one battery; or
if the battery controller detects, via the frequency measurement circuit, that the frequency of the circuit deviates from the predefined frequency by more than the predefined frequency shift, then the battery controller controls the switching arrangement to electrically disconnect the at least one electrical contact from the at least one battery.

7. The PPE system of claim 1, wherein the article of PPE further comprises a conductive object disposed proximal to the battery pack interface, wherein the battery pack further comprises a capacitive sensor communicably coupled to the battery controller, wherein the battery controller is configured to control the capacitive sensor to detect a proximal presence or absence of the conductive object via capacitive coupling, and wherein the battery controller controls the switching arrangement to electrically connect the at least one electrical contact to the at least one battery or electrically disconnect the at least one electrical contact from the at least one battery based on the proximal presence or absence of the conductive object.

8. The PPE system of claim 1, wherein the switching arrangement comprises a transistor communicably coupled to the battery controller, wherein the transistor is switchable between an on state and an off state based on a control signal from the battery controller, wherein the battery controller is further configured to switch the transistor to the on state in order to allow flow of electric current from the at least one battery to the at least one electrical contact, and wherein the battery controller is further configured to switch the transistor to the off state in order to prevent flow of electric current from the at least one battery to the at least one electrical contact.

9. The PPE system of claim 1, wherein the plurality of electrical contacts comprises a positive electrical contact and a negative electrical contact, wherein the battery controller is further configured to provide an alternating signal between the positive electrical contact and the negative electrical contact, wherein the battery controller is further configured to determine an effective capacitance between the positive electrical contact and the negative electrical contact due to the alternating signal, wherein the battery controller is further configured to determine whether the battery pack is electrically connected to the battery pack interface based on the effective capacitance, and wherein:
if the battery controller detects that the battery pack is electrically connected to the battery pack interface based on the effective capacitance, the battery controller controls the switching arrangement to electrically connect the at least one electrical contact to the at least one battery; and
if the battery controller detects that the battery pack is not electrically connected to the battery pack interface based on the effective capacitance, the battery controller controls the switching arrangement to electrically disconnect the at least one electrical contact from the at least one battery.

10. The PPE system of claim 1, wherein the battery pack further comprises a motion detector communicably connected to the battery controller, wherein the battery controller is configured control the motion detector to detect a motion of the battery pack, and wherein the battery controller is further configured to enter a low power state after some time has elapsed with the battery pack not in motion.

11. The PPE system of claim 10, wherein the motion detector comprises at least one of an accelerometer and a gyro sensor.

12. The PPE system of claim 1, wherein the one or more predefined conditions comprise at least one of a resonant frequency condition, a capacitance condition, an electromagnetic condition, and a mechanical condition.

13. The PPE system of claim 1, wherein the article of PPE provides at least one of: respiratory protection, hearing protection, vision protection, fall protection, and head protection.

14. The PPE system of claim 1, wherein the article of PPE is a powered air-purifying respirator (PAPR).

15-18. (canceled)

19. A method comprising:
providing an article of PPE, the article of PPE comprising a battery pack interface and one or more components that are electrically powered and configured to receive electrical power via the battery pack interface;
providing a battery pack, wherein the battery pack is configured to physically and electrically connect to and disconnect from the battery pack interface of the article of PPE, the battery pack comprising:
at least one battery;
a plurality of electrical contacts configured to electrically connect the at least one battery to the one or more components of the article of PPE via the battery pack interface, wherein the at least one battery is configured to electrically power the one or more components of the article of PPE via the plurality of electrical contacts; and
a switching arrangement electrically disposed between at least one electrical contact from the plurality of electrical contacts and the at least one battery, wherein the switching arrangement is configured to selectively electrically connect the at least one electrical contact to the at least one battery and selectively electrically disconnect the at least one electrical contact from the at least one battery;
controlling the switching arrangement to electrically connect the at least one electrical contact to the at least one battery; and
controlling the switching arrangement to electrically disconnect the at least one electrical contact from the at least one battery when the article of PPE is not in use based on one or more predefined conditions so as to prevent corrosion of the plurality of electrical contacts when a conductive liquid contacts the plurality of electrical contacts.

20. The method of claim 19, wherein the switching arrangement comprises:
a waterproof switch electrically disposed between the at least one electrical contact and the at least one battery, wherein the waterproof switch is configured to electrically connect the at least one electrical contact to the at least one battery in a first mode and electrically disconnect the at least one electrical contact from the at least one battery in a second mode, and wherein, upon physical connection of the battery pack to the battery pack interface of the article of PPE, the waterproof switch mechanically or electromagnetically switches to the first mode; and
a transistor electrically disposed between the at least one electrical contact and the at least one battery and in parallel to the waterproof switch, wherein the transistor is configured to electrically connect the at least one electrical contact to the at least one battery when switched on and electrically disconnect the at least one electrical contact from the at least one battery when switched off;
wherein the method further comprises:
determining whether the waterproof switch is in the first mode or the second mode;
upon determining that the waterproof switch is in the first mode, determining whether the one or more components of the article of PPE are receiving power from the at least one battery via the plurality of electrical contacts;
upon determining that the one or more components of the article of PPE are receiving power from the at least one battery via the plurality of electrical contacts, controlling the switching arrangement to switch on the transistor in order to bypass the waterproof switch and electrically connect the at least one electrical contact to the at least one battery regardless of the waterproof switch being in the first mode or the second mode; and
upon determining that the one or more components of the article of PPE are not receiving power from the at least one battery via the plurality of electrical contacts, controlling the switching arrangement to switch off the transistor.

21. The method of claim 19, further comprising:
controlling the switching arrangement to electrically connect the at least one electrical contact to the at least one battery during a plurality of recurring time durations spaced apart by a plurality of intermediate time durations;
controlling the switching arrangement to electrically disconnect the at least one electrical contact from the at least one battery during the plurality of intermediate time durations;
detecting if there is communication between the article of PPE and the at least one battery during the plurality of recurring time durations; and
upon detecting communication between the article of PPE and the at least one battery during any one of the plurality of recurring time durations, controlling the switching arrangement to electrically connect the at least one battery to the at least one electrical contact until the one or more components of the article of PPE stop receiving power from the at least one battery via the plurality of electrical contacts.

22. The method of claim 19, wherein the article of PPE further comprises an article circuit disposed proximal to the battery pack interface and tuned to a predefined frequency, wherein the battery pack further comprises a frequency measurement circuit, and wherein the method further comprises:
controlling the frequency measurement circuit to detect a frequency of the article circuit;
controlling the switching arrangement to electrically connect the at least one electrical contact to the at least one battery upon detection, via the frequency measurement circuit, of the article of PPE based on the predefined frequency; and
controlling the switching arrangement to electrically disconnect the at least one electrical contact from the at least one battery if the article circuit of the article of PPE is not detected via the frequency measurement circuit.

23. The method of claim 19, wherein the battery pack further comprises a housing and a circuit disposed proximal to an exterior of the housing, wherein the circuit is tuned to a predefined frequency, wherein the battery pack further comprises a frequency measurement circuit disposed interior to the housing, and wherein the method further comprises:
controlling the frequency measurement circuit to detect a frequency of the circuit;
controlling the switching arrangement to connect the at least one electrical contact to the at least one battery if the frequency of the circuit deviates from the predefined frequency by less than a predefined frequency shift; and
controlling the switching arrangement to electrically disconnect the at least one electrical contact from the at least one battery if the frequency of the circuit deviates from the predefined frequency by more than the predefined frequency shift.

24. The method of claim 19, wherein the article of PPE further comprises a conductive object disposed proximal to the battery pack interface, wherein the battery pack further comprises a capacitive sensor, and wherein the method further comprises:
controlling the capacitive sensor to detect a proximal presence or absence of the conductive object via capacitive coupling; and
controlling the switching arrangement to electrically connect the at least one electrical contact to the at least one battery or electrically disconnect the at least one electrical contact from the at least one battery based on the proximal presence or absence of the conductive object.

25. The method of claim 19, wherein the plurality of electrical contacts comprises a positive electrical contact and a negative electrical contact, and wherein the method further comprises:
providing an alternating signal between the positive electrical contact and the negative electrical contact;
determining an effective capacitance between the positive electrical contact and the negative electrical contact due to the alternating signal;
determining whether the battery pack is electrically connected to the battery pack interface based on the effective capacitance;
controlling the switching arrangement to electrically connect the at least one electrical contact to the at least one battery upon determining that the battery pack is electrically connected to the battery pack interface based on the effective capacitance; and
controlling the switching arrangement to electrically disconnect the at least one electrical contact from the at least one battery upon determining that the battery pack is not electrically connected to the battery pack interface based on the effective capacitance.

26. The method of claim 19, wherein the one or more predefined conditions comprise at least one of a resonant frequency condition, a capacitance condition, an electromagnetic condition, and a mechanical condition.
